(19) United States
(12) Patent Application Publication
(10) Pub. No.: US 2016/0156096 A1
(43) Pub. Date: Jun. 2, 2016

(54) RFID Antenna

(71) Applicants: Yonghao NI, Fredericton (CA); Christopher David ROUSE, McLeod Hill (CA); Bruce Gordon COLPITTS, Fredericton (CA); Joseph Alexander MOSSELER, New Maryland (CA); KNOWCHARGE INC., Fredericton (CA)

(72) Inventors: Yonghao NI, Fredericton (CA); Christopher David ROUSE, McLeod Hill (CA); Bruce Gordon COLPITTS, Fredericton (CA); Joseph Alexander MOSSELER, New Maryland (CA)

(21) Appl. No.: 14/906,008

(22) PCT Filed: Jul. 21, 2014
(86) PCT No.: PCT/CA2014/000576

§ 371 Date: Jan. 19, 2016

Related U.S. Application Data
(60) Provisional application No. 61/856,140, filed on Jul. 19, 2013.

(51) Int. Cl. H01Q 1/38; H01Q 9/04; H01Q 1/36; H01B 1/24

(52) U.S. Cl. CPC H01Q 1/38; H01B 1/24; H01Q 9/04; H01Q 1/368; B82Y 30/00

(57) ABSTRACT

The present disclosure relates to an antenna, comprising (a) substrate; and (b) a composition, comprising, (i) an electrically conductive material; and (ii) a binder; wherein the composition is adjacent to the substrate.

### RELATED APPLICATIONS

This application claims priority to U.S. Provisional Patent Application No. 61/856,140 filed on Jul. 19, 2013, the entire contents of which are hereby incorporated by reference.

### FIELD

The present disclosure relates to an RFID antenna comprising an electrically conductive material.

### BACKGROUND

Recent developments in semiconductor and transducer systems, including microelectromechanical systems (MEMS) have seen the incorporation of low cost microelectronic components into low power systems. These systems can be applied to antennas in RFID tags, making up either active or passive tags. RFID tags can operate at low (LF), high (HF), or ultra-high frequency (UHF) ranges. Passive, UHF RFID tags have become of interest due to the fact that they do not require an internal energy source. Traditionally these tags use classic metallic conductors such as copper or aluminium; however, it has become of interest to develop sustainable and renewable alternatives to costly metallic antennas and produce tags with other desirable operational characteristics such as sufficient mechanical flexibility, increased versatility, multiuse ability, mass production, and economic feasibility.

### SUMMARY

The present disclosure relates to antennas in RFID tags or devices, in which the antenna comprises a composition comprising an electrically conductive material.

In one embodiment, there is provided an antenna, for example an RFID antenna, comprising:

a substrate; and

a composition, comprising,
(i) an electrically conductive material; and
(ii) a binder;
   wherein the composition is adjacent to the substrate.

In one embodiment, the electrically conductive material has a conductivity which is sufficient to operate as an antenna.

In one embodiment, the composition has a viscosity of at least 100 cP.

In another embodiment, the electrically conductive material comprises graphite, carbon black, carbon fibrils or carbon fibers, nanofiber, and carbon nanotubes, a conjugated conductive polymer, electrically conductive polymer composite, or mixtures thereof.

In one embodiment, the composition comprising the antenna has a conductivity of at least 300 S/m.

In another embodiment, the substrate comprises a paper-based substrate.

In other embodiments, the disclosure also includes an RFID tag, sticker or system comprising:
(i) an antenna as described above;
(ii) a co-axial connector; and
(iii) a wire connecting the antenna to the connector.

The co-axial connector can then be connected to a suitable circuit for RFID purposes or to another circuit that may use the antenna as described above and in which the antenna provides suitable performance

Other features and advantages of the present application will become apparent from the following detailed description. It should be understood, however, that the detailed description and the specific examples while indicating preferred embodiments of the application are given by way of illustration only, since various changes and modifications within the spirit and scope of the application will become apparent to those skilled in the art from this detailed description.

Further aspects and advantages of the embodiments described herein will appear from the following description taken together with the accompanying drawing.

### BRIEF DESCRIPTION OF THE DRAWINGS

For a better understanding of the embodiments described herein and to show more clearly how they may be carried into effect, reference will now be made, by way of example only, to the accompanying drawings which shows at least one exemplary embodiment, and in which:

FIG. 1 is a schematic representation of an RFID system in embodiment of the disclosure;

FIG. 2 is an RFID system in a first embodiment of the disclosure; and

FIG. 3 is an RFID system in a second embodiment of the disclosure.

### DETAILED DESCRIPTION

### (I) Definitions

The term “antenna” as used herein refers to a conductive component of an RFID tag, sticker or device or another electronic device or circuit for radiating or receiving electromagnetic radiation, such as radio waves, and comprised of the compositions of the present disclosure.

The term “adjacent” as used herein refers to the relationship between the substrate and the composition forming the antenna and means that the substrate and the antenna are in contact with each other or in closely spaced relationship to each other. For example, a composition of the disclosure is coated on a substrate, and therefore, the composition and the substrate are in contact with each other.

The term “electrically conductive material” as used herein refers to any compound, material, or substance with the ability to conduct an electrical current sufficient for an antenna to radiate or receive electromagnetic radiation.

The term “polymer” as used herein has its normal meaning and refers to a macromolecular substance composed of one or more repeating monomers, and includes linear, branched, and cross-linked polymers, and combinations thereof. The polymer can comprise copolymers, block copolymers, graft copolymers, alternating copolymers, and random copolymers.

The term “electrically conductive polymer” as used herein refers to any polymer which is inherently or intrinsically capable of electrical conductivity. Examples of electrically conductive polymers include ionically conductive polymers, charge transfer polymers, conjugated conductive polymers etc.

The term “conjugated conductive polymer” as used herein refers to a polymer having an extended system of alternating single and double- bonds and/or triple bonds, i. e. an extended π-system and which is doped with a conductive dopant and has sufficient electrical conductivity to conduct an electrical charge in operation as an antenna.

The term “ionically conductive polymer”, or “charged polymer”, as used herein refers to a polymer which possesses an inherent positive (cationic) or negative (anionic) charge, and conducts an electrical charge.

The term “charge transfer polymer” as used herein refers to a polymer complex which conducts an electrical charge as a result of electron transfer between an electron donor (D) and acceptor (A) molecules.

The term “composite” as used herein refers to a material in which the presence of two or more constituent materials remains separate and distinct within the finished material, in which one of the materials is electrically conductive.

The term “electrically conductive polymer composite” as used herein refers to a composite comprised of an electrically conductive polymer and another material or substance, for example, which alters, or increases, the electrical conductivity of the polymer so that it has sufficient electrical conductivity to conduct an electrical charge in operation as an antenna, or other non-conductive material such as a carrier material.

The term “substrate”, as used herein, refers to the layer that provides mechanical support for the antenna. Typically, the substrate is not involved in radiating or receiving the electromagnetic radiation.

The term “binder” as used herein refers to a component used to bind or adhere the electrically conductive material to the substrate, and is optionally electrically conductive.

### (II) Antennas

The present disclosure relates to antennas, such as an RFID antenna, which are able to radiate and receive electromagnetic waves, such as radio waves. The antennas of the present disclosure are prepared from a composition comprising an electrically conductive material and a binder. In one embodiment, the compositions can be applied to any surface or substrate, for example, a paper-based surface, clay-based substrate, and applied in any shape, to form the antenna component of an RFID tag, device or sticker or another electronic device or circuit. The antenna can have various shapes and sizes depending on certain characteristics of the use of the antenna such as the operating frequency range, for example.

Accordingly, in one embodiment, the present disclosure includes an antenna, for example an RFID antenna, comprising:

a substrate; and

a composition, comprising,

1(i) an electrically conductive material; and
(ii) a binder;
   wherein the composition is adjacent to the substrate.

In another embodiment, the present disclosure includes an antenna, for example an RFID antenna:

a substrate; and

a composition, consisting essentially of, or consisting of,
(i) an electrically conductive material; and
(ii) a binder;
   wherein the composition is adjacent to the substrate.

In one embodiment, the viscosity of the composition is sufficient for the composition to be applied or coated on the substrate and maintain the desired shape or form of the antenna. In one embodiment, the viscosity of the composition is sufficient such that the shape of the antenna is maintained and the composition does not bleed into the substrate or run on the substrate. For example, when the substrate is a paper-based (cellulose-based substrate), the viscosity of the composition is sufficient such that the composition will not bleed into the fibers of the cellulose after application of the composition to the substrate.

In another embodiment, the composition has a viscosity of at least about 100 centiPoise (cP), optionally at least about 200 cP, optionally at least about 300, optionally at least about 400 cP, or optionally at least about 500 cP. In one embodiment, the composition has a viscosity of between about 100 cP to 2000 cP, or about 200 cP to about 1800 cP, or about 400 cP to about 1500 cP.

In another embodiment, the antenna has a conductivity of at least about 300 S/m, or at least about 350 S/m, or at least about 400 S/m, or at least about 450 S/m, or at least about 500 S/m, or at least about 1,000 S/m, or at least about 10,000 S/m. In one embodiment, the conductivity of the antenna is modulated by the selection of the electrically conductive material. It is therefore possible to tailor the conductivity of the antenna for each particular application by selecting an appropriate electrically conductive material.

In another embodiment, the composition comprises a binder which adheres the components of the composition together such that the composition can be applied to a substrate. In one embodiment, the binder also aids in affixing the composition to the substrate. In one embodiment, the binder comprises latex, synthetic latex, starch, polyvinyl alcohol, soy protein, carboxyl methyl cellulose (CMC), or mixtures thereof. In one embodiment, the binder comprises latex or synthetic latex. In one embodiment, the synthetic latexes comprise polymers or copolymers of ethylenically unsaturated compounds, such as copolymers of the styrene and butadiene type, which possibly also have a monomer containing a carboxyl group, such as acrylic acid, itaconic acid or maleic acid, and polyvinyl acetate having monomers that contain carboxyl.

In another embodiment, the binder of the present disclosure is also electrically conductive. In one embodiment, an electrically conductive polymer is co-polymerized with a binder as defined above, for example, a co-polymer of poly-DADMAC and synthetic latex, resulting in an electrically conductive binder. In other embodiments, an electrically conductive material such as an electrically conductive polymer such as poly-DADMAC is physically mixed with the binder to obtain an electrically conductive binder.

In another embodiment, the electrically conductive material comprises graphite, graphite derivatives, carbon black, carbon fibrils or carbon fibers, nanofibers, and carbon nanotubes, metal particles, a conjugated conductive polymer or an electrically conductive polymer composite.

In another embodiment of the disclosure, the electrically conductive material comprises a conjugated conductive polymer. Conjugated conductive polymers of the disclosure comprise a conjugated π-system which allow for the polymers which form part of the composition to conduct electricity. In one embodiment, the conjugated conductive polymer comprises poly(phenylenevinylenes), polyfluorenes, poly(spirobifluorenes), polythiophenes, poly(p-phenylenes), poly(anilines), poly(pyrroles), copolymers thereof, or mixtures thereof. In one embodiment, the conjugated conductive polymer comprises polypyrrole. In one embodiment, the conjugated conductive polymers are doped with electrically conductive dopants to alter or increase their electrical conductivity. For example, in some embodiments, the conjugated polymers are doped with 2-naphthalene sulfonic acid (NSA), 9,10-anthraquinone-2-sulfonic acid sodium salt (AQSA-Na), p-toluenesulfonic acid or its sodium salt (PTSA or PTSA-Na), benzenesulfonic acid (BSA), or dodecylbenzene sulfonic acid or its sodium salt (DBSA and DBSA-Na). In another embodiment of the disclosure, the conductive dopant is any compound which alters, or optionally increases, the conductivity of the conjugated conductive polymer, resulting in an RFID antenna with capability to radiate and/or receive electromagnetic radiation, such as radiowaves.

In one embodiment, the electrically conductive polymer composite comprises an electrically conductive polymer such as a charge transfer polymer, a charged polymer, or mixtures thereof, and another material or substance which alters or increases the electrical conductivity of the composite such that the composite has sufficient electrical conductivity to conduct an electrical charge in operation as an antenna. In one embodiment, the composite comprises an electrically conductive polymer and graphite, copper, aluminum or nano- or micro-particles of silver-shelled copper.

In other embodiments, the electrically conductive polymer comprises a charge transfer polymer complex which conducts an electrical charge as a result of electron transfer between an electron donor (D) and acceptor (A) molecules. Examples of charge transfer polymers include tetrathiofulvalene (an electron donor) and 7,7,8,8-tetracyano-p-quinodimethane (electron acceptor).

In another embodiment, the electrically conductive polymer comprises an ionically conductive polymer (or a charged polymer), for example, a cationic polymer or an anionic polymer. Cationic polymers contain a positive charge, such as an ammonium moiety, a phosphonium moiety, or a sulphonium moiety. Such cationic groups are able to dissociate to provide opposite ionic charges resulting in subsequent ion migration between coordination sites, which are generated by the slow motion of polymer chain segments.

Examples of cationic polymers include, but are not limited to, 2-hydroxyethyl methacrylate (HEMA), 2-acrylamido-2-methylpropane sulfonic acid (AAMPS), 3-methacryloylaminopropyl-trimethyl ammonium chloride (MAPTAC), or N,N-diallyl-N,N-dimethyl ammonium chloride (DADMAC). Polymers such as DADMAC are water soluble and therefore, in one embodiment, the compositions of the disclosure are aqueous solutions which are mixed with the binder and simply sprayed or coated onto the support layer, and as such, environmentally hazardous organic solvents do not need to be used. In one embodiment, the electrically conductive polymers are water soluble. Further, polymers such as DADMAC are colourless, and therefore, the antennas of the disclosure are prepared in any colour by the addition of the appropriate pigment or dye. In one embodiment, the electrically conductive polymers are colourless. Polymers such as DADMAC are inherently charged or ionic (positive charge), and therefore have an affinity to negatively charged support layers, such as cellulose paper layers.

Examples of anionic polymers include, but are not limited to, polyacids containing mono-, di- or tri-acid monomers or their neutralized salts. The polyacids containing di-acid units include, but are not limited to, polyvinylmethyl/maleic acid (PVM/MA) copolymer. Examples of polyacid or salt with a mono-acid unit include, but not limited to, the acrylic acid copolymers, or their salts, such as vinylpyrrolidone/acrylates/lauryl methacrylate copolymer. Anionic polymers are inherently charged or ionic (negative charge), and therefore have an affinity to positively charged support layers.

In another embodiment, the composition further comprises a carrier material. In one embodiment, the carrier material comprises clay, such as Kaolinite, talc, calcium carbonate or bentonite. In one embodiment, the carrier material modifies certain properties of the composition which allows for easier handling of the composition. For example, when the composition is a mixture of a conjugated conductive polymer and a binder, the composition can be tacky, which can result in difficulties when applying the composition to a substrate. In one embodiment, the addition of a carrier material, such as a clay, allows for the viscosity of the composition to be modified allowing for more facile application. In one embodiment, the carrier material modifies the viscosity, pH and/or flow properties of the composition.

In other embodiments, the electrically conductive polymer composite comprises any polymer described herein and, an electrically conductive dopant and/or carrier material. For example, in one embodiment, the electrically conductive material is an electrically conductive polymer composite comprising polypyrrole and a carrier material such as a cellulosic fiber, or clay such as Kaolinite, talc, calcium carbonate, bentonite, to form the composite, optionally with an electrically conductive dopant.

In another embodiment, the composition further comprises a surfactant or dispersant, such as sodium dodecyl sulphate (SDS), which help in the handling and application of the composition to the substrate. In another embodiment, the composition may further comprise pigments and/or dyes.

The antenna of the present disclosure further comprises a substrate, upon which the antenna is supported. It will be understood that the composition which forms the antenna is coated on a substrate forming pre-formed antennas. The pre-formed antennas are then attached to any item, product, package etc., in which it is desirous to place an RFID tag, system or sticker. For example, the pre-formed antenna can be attached to a package, such as a packaging box. In this embodiment, the pre-formed antenna is affixed with glue or other adhesive substance to the packaging box. In one embodiment, the substrate is any organic material (e. g., pulp fibers) or inorganic material (e. g. clay), or combination thereof, that can support the electrically conductive material.

In another embodiment, the composition can be coated or painted directly on the item, package or product. In this embodiment, the substrate is the particular item, package or product. For example, during manufacture of a packaging box, the composition is coated directly on the packaging box, either before or after the box is folded into its final shape. In this embodiment, the composition can be coated on the item, product or package in shape desired by the end user. For example, the composition can be coated on the item, package or product in the shape of a logo.

In one embodiment, the substrate is a paper-based layer, such as a cellulosic paper layer (cardboard, paper, cellophane) or a hemicellulosic paper layer, or other substrates such as a calcium carbonate paper layer, a clay substrate, or a biodegradable polymer layer. In one embodiment, the biodegradable polymer layer comprises polycaprolactone (PCL), polyvinyl alcohol (PVOH, PVA, or PVAI), and polylactic acid or polylactide (PLA). In another embodiment, the substrate is a cellulosic paper layer which also contains clay.

In one embodiment of the disclosure, the composition comprises
(i) about 10% to about 90%, or about 40-70% of an electrically conductive material; and
(iii) about 10% to about 90%, more preferably 30-60% of a binder.

FIG. 1 shows a schematic representation of an antenna tag, sticker or system (10) using the compositions of the present disclosure. Two polymeric antennas (12) are connected to a co-axial connector (16) through wires (14). In one embodiment, the compositions of the present disclosure comprising the antennas (12) can be coated, sprayed or painted in any shape. The antennas (12) can be electrically and physically coupled to the co-axial connector (16) via a suitable conductive element such as conductive epoxy, for example.

In another embodiment of the disclosure, the composition forming the antenna is coated on a substrate in a thickness of between about 10 μm to about 600 μm, or between about 25 μm to about 300 μm, or between about 50 μm to 150 μm. It will be understood by those skilled in the art that the thickness of the antenna is a factor which controls the conductance of the antenna. It will be understood that as an antenna becomes thicker, the conductance of the antenna increases. In one embodiment, the conductance of the antenna is controlled by altering the thickness of the composition which is painted, coated, sprayed etc. upon the substrate.

### (III) Process for Preparing Antennas

The present disclosure also includes processes for preparing antennas.

In one embodiment, the components of the composition are mixed together, and the composition is applied to a substrate to form the antennas of the present disclosure. For example, in one embodiment, an electrically conductive polymer composite is prepared by the in-situ polymerization of a monomer which is used to prepare a conjugated conductive polymer, such as pyrrole (to form polypyrrole) in the presence of a carrier material, such as clay and an electrically conductive dopant (for example, NSA). The resulting electrically conductive polymer composite is then used to prepare a mixture containing a binder, and optionally an electrically conductive material, such as graphite or metal particles, depending on the conductivity that is required. The mixture is then applied to a substrate, such as a paper surface (optionally containing clay) via coating to form the antenna.

In another embodiment, an electrically conductive material such as graphite or metal particles is mixed with a binder to form a mixture, and optionally a carrier. The mixture is then applied to a substrate, such as a paper surface via coating to form the antenna.

In another embodiment, when the electrically conductive material is a polymer, the polymers are polymerized during mixing of the other components of the composition. For example, when the polymer comprises polypyrrole, the monomers which make up the polymer, pyrrole, are added to carrier, such as clay and an electrically conductive dopant. The mixture is then mixed under conditions for the in situ polymerization to form the electrically conductive polymer or polymer composite, for example by heating the mixture and/or by the addition of a free radical initiator. The resulting electrically conductive polymer composite is then used to prepare a mixture containing a binder, and optionally an electrically conductive material, such as graphite or metal particles, depending on the conductivity that is required. Once the electrically conductive polymer or composite has been formed in situ and subsequently mixed with a binder, the composition is applied to a substrate to form the antenna.

In one embodiment, a support layer as defined above, such as a cellulosic or lignocellulosic paper layer is coated with the composition as defined above, and then subsequently dried resulting in the antenna. The composition can be applied to the support layer by any means known in the art, for example, by coating, sizing, spraying or painting the composition onto the support layer.

### (IV) Methods and Uses of Articles and Multi-Layered Material

The present disclosure includes antennas, such as RFID antennas, which can be attached, affixed, coated, sprayed or placed on any article or item, such as a product, packaging box etc., where it is desirous to place an RFID tag.

As the antennas of the present disclosure do not utilize typical materials used in RFID systems, such as metallic copper etc., the costs of preparing the antennas of the present disclosure are much less. Further, as the composition which form the antennas of the present disclosure can be coated on many surfaces, and in many shapes, the antennas can be formed into many different shapes, such as a logo etc. For example, the antenna may be shaped as a dipole antenna as shown in FIG. 1, or the antenna may be shaped as a loop or a spiral antenna for use at lower frequencies on the order of tens of MHz. Alternatively, other shapes can be used such as meandering shapes. In some embodiments, the antenna of the present disclosure may be a micro-strip patch antenna.

The antennas of the present disclosure may also be used with conventional circuits. In the example embodiment of FIG. 1, the coaxial connector (16) would be electrically and physically coupled with a corresponding connector on the RFID circuit.

In one embodiment, there is included a method of preparing an RFID antenna, comprising (i) selecting an antenna design to be applied to a substrate; (ii) providing a composition as defined above to a device for applying the composition to the substrate; and (iii) applying the composition to the substrate. The method can be repeated to obtain a thicker antenna as required.

In one embodiment, the antennas of the present disclosure are used in RFID tags, stickers or systems. The RFID system includes a machine-readable identification tag connected to the antenna. The antenna is adapted to radiate in response to an interrogation frequency from an interrogator unit. The RFID unit may also include a power source for the antenna for transmitting and receiving and a signal processor for receiving. The antennas of the present disclosure are flexible and can conform to any shape required.

The antennas of the present disclosure are useful in any application in which an RFID system has application. For example, the antennas are useful for inventory tracking (RFID antennas could be coated directly on packaging/clothing); EZ-Pass-type applications for tolls and parking (an antenna on a substrate could be stuck onto the car windshield); rescue/emergency worker locating (allowing emergency workers, when going into a dangerous situation, to be fitted with an unobtrusive antenna for location finding); location finding (where, for example, an antenna could be directly printed onto a lift pass at a ski resort, and if a skier is lost, tracking could be performed); and public transportation payment option (public transportation payment options such as bus, rail and subway).

Although the disclosure has been described in conjunction with specific embodiments thereof, if is evident that the embodiments described herein have been provided as example and that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present disclosure.

### EXAMPLES

The operation of the disclosure is illustrated by the following representative examples. As is apparent to those skilled in the art, many of the details of the examples may be changed while still practicing the disclosure described herein.

### Example 1

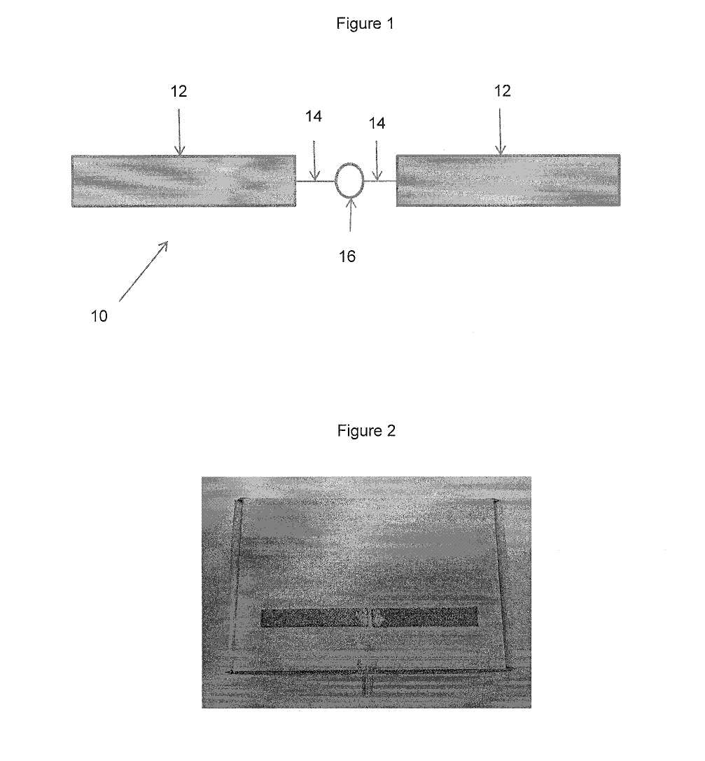

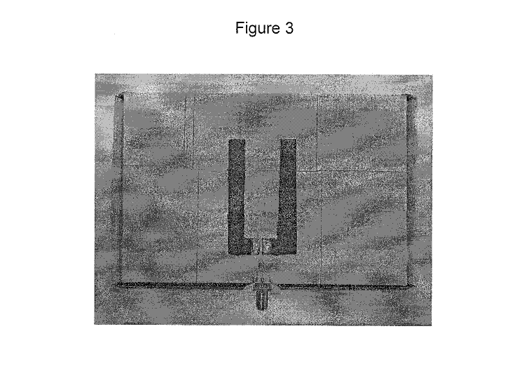

A mixture of 1% wt sodium dodecyl sulphate (SDS) dispersant, 42% wt particle graphite (>25 nm), 11.4% latex binder (as active latex), and 45.6% deionised H₂O was prepared. The mixture was stirred at 8000 rpm for 20 minutes. The mixture was then applied to the surface of a sample box. The sample was coated on the box using a pre-cut negative in the shape of a half-wave dipole antenna which is set to resonate at 915 MHz. The coating for each has a conductivity of approximately 1000 S/m. The antenna was mounted with a balun (50 ohm), a gold plated edge-mount SMA connector and conductive epoxy (as shown in FIGS. 2 and 3). The antenna in FIG. 2 was a half-wave dipole (1 cm×6 cm each). The dimensions of the antenna shown in FIG. 3 were 6 cm tall×0.8 cm wide (top)×2 cm wide (bottom).

While the present disclosure has been described with reference to what are presently considered to be the examples, it is to be understood that the disclosure is not limited to the disclosed examples. To the contrary, the disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

### REFERENCES

[1] B. Huang, G. J. Kang, and Y. Ni, “Preparation of conductive paper by in-situ polymerization of pyrrole in a pulp fibre system,” Pulp Paper Can., vol. 107, no. 2, pp. 38-42, 2006.
[2] L. J. van der Pauw, “A method of measuring specific resistivity and hall effect of discs of arbitrary shape,” Philips Res. Rep., vol. 13, no. 1, pp. 1-9, February 1958.
[3] S. A. Schelkunoff and H. T. Friis, Antennas: Theory and Practice. New York, N.Y., USA: Wiley, 1952.
[4] C. A. Balanis, Antenna Theory: Analysis and Design, 3^{rd} ed. Hoboken, N.J., USA: Wiley, 2005.
[5] K. V. S. Rao, P. V. Nikitin, and S. F. Lam, “Antenna design for UHF RFID tags: A review and a practical application,” IEEE Trans. Antennas Propag., vol. 53, no. 12, pp. 3870-3876, December 2005.

1. An antenna, comprising:
a. a substrate; and
b. a composition, comprising,
(i) an electrically conductive material; and
(ii) a binder;
wherein the composition is adjacent to the substrate.

2. The antenna according to claim 1, wherein the antenna has a conductivity of at least 300 S/m.

3. The antenna of claim 1, wherein the electrically conductive material comprises graphite, carbon black, carbon fibrils or carbon fibers, nanofiber, and carbon nanotubes, an electrically conductive polymer or an electrically conductive polymer composite.

4. The antenna according to claim 3, wherein the electrically conductive polymer comprises poly(phenylenevinylenes), polyfluorenes, poly(spirobifluorenes), polythiophenes, poly(p-phenylenes), poly(anilines), poly(pyrroles), copolymers thereof, or mixtures thereof, doped with a conductive dopant such as 2-naphthalene sulfonic acid (NSA), 9,10-anthraquinone-2-sulfonic acid sodium salt (AQSA-Na), p-toluenesulfonic acid or its sodium salt (PTSA or PTSA-Na), benzenesulfonic acid (BSA), or dodecylbenzene sulfonic acid or its sodium salt (DBSA and DBSA-Na).

5. The antenna of claim 3, wherein the electrically conductive polymer composite comprises a charge transfer polymer or an ionically conductive polymer and an electrically conductive material such as graphite, copper, aluminum or nano- or micro-particles of silver-shelled copper.

6. The antenna according to claim 5, wherein the charge transfer polymer comprises tetrathiofulvalene and 7,7,8,8-tetracyano-p-quinodimethane.

7. The antenna according to claim 5, wherein the ionically conductive polymer comprises a cationic polymer or an anionic polymer.

8. The antenna according to claim 7, wherein the ionically conductive polymer is a cationic polymer.

9. The antenna according to claim 8, wherein the ionically conductive cationic polymer comprises ammonium, phosphonium or sulfonium groups.

10. The antenna according to claim 9, wherein the ionically conductive cationic polymer comprises 2-hydroxyethyl methacrylate (HEMA), 2-acrylamido-2-methylpropane sulfonic acid (AAMPS), 3-methacryloylaminopropyl-trimethyl ammonium chloride (MAPTAC), or N,N-diallyl-N,N-dimethyl ammonium chloride (DADMAC).

11. The antenna according to claim 10, wherein the ionically conductive polymer comprises DADMAC.

12. The antenna according to claim 1, wherein the binder comprises latex, synthetic latex, starch, polyvinyl alcohol, soy protein, carboxyl methyl cellulose (CMC), or mixtures thereof.

13. The antenna according to claim 1, wherein the composition further comprises a carrier, such as a particulate carrier.

14. (canceled)

15. The antenna according to claim 1, wherein the substrate comprises a cellulosic paper layer, hemicellulosic paper layer, a calcium carbonate paper layer, or a biodegradable polymer layer.

16. The antenna according to claim 15, wherein the the biodegradable polymer layer comprises polycaprolactone (PCL), polyvinyl alcohol (PVOH, PVA, or PVAI), and polylactic acid or polylactide (PLA).

17. The antenna according to claim 15, wherein the cellulosic paper layer further comprises clay.

18. The antenna according to claim 1, wherein the antenna further comprises an electrical connector coupled to the composition and the substrate.

19. The antenna according to claim 18, wherein the connector comprises a coaxial connector.

20. The antenna according to claim 18, wherein the electrical connector is coupled to the composition and the substrate via a conductive epoxy.

21. The antenna according to claim 1, wherein the antenna comprises a dipole antenna, a loop antenna, a spiral antenna or a micro-strip patch antenna.
